(19) United States
(12) Patent Application Publication
(10) Pub. No.: US 2025/0190671 A1
(43) Pub. Date: Jun. 12, 2025

(54) DESIGN METHOD FOR SEMICONDUCTOR DEVICE

(71) Applicant: Samsung Electronics Co., Ltd., Suwon-si (KR)

(72) Inventors: Garoom Kim, Suwon-si (KR); Bonghyun Lee, Suwon-si (KR)

(21) Appl. No.: 18/757,814

(22) Filed: Jun. 28, 2024

(30) Foreign Application Priority Data
Dec. 7, 2023 (KR) 10-2023-0176605

(51) Int. Cl. G06F 30/392; G06F 30/327; G06F 119/12

(52) U.S. Cl. CPC G06F 30/392; G06F 30/327; G06F 2119/12

(57) ABSTRACT

A method of designing a semiconductor device includes generating input data defining an integrated circuit, generating, based on the input data, layout data in which at least some selected standard cells among a plurality of standard cells stored in a library are disposed and connected, and analyzing timing of the integrated circuit using the layout data. The library stores physical information and timing information of each of the plurality of standard cells and, for at least one standard cell, first timing information generated from a first layout context, and second timing information generated from a second layout context having an area of an interconnection pattern smaller than an area of an interconnection pattern of the first layout context, are stored in the library. The second timing information, which is different from the first timing information, is applied to at least one selected standard cell among the selected standard cells.

### CROSS-REFERENCE TO RELATED APPLICATION(S)

This application is based on and claims the benefit of priority under 35 USC 119 (a) of Korean Patent Application No. 10-2023-0176605 filed on Dec. 7, 2023 in the Korean Intellectual Property Office, the entire disclosure of which is incorporated herein by reference for all purposes.

### BACKGROUND

Aspects of the present inventive concept relate to a method of designing a semiconductor device.

Integrated circuits included in semiconductor devices may be designed by disposing and connecting standard cells predefined in a library. Each of the standard cells may include physical information defining the location and shape of the active region, gate structure, and interconnection pattern actually formed on the semiconductor substrate, and timing information determined according to the process of forming semiconductor elements and the size of each semiconductor element, and may use timing information to perform a simulation task to determine whether the integrated circuit designed with the standard cells operates normally. However, since timing information is generated assuming the worst case, normal operations may be determined to be impossible in simulation work and timing analysis even though the designed integrated circuit may actually operate.

### SUMMARY

Example embodiments provide a method of designing a semiconductor device in which the accuracy of simulation work of integrated circuits designed using standard cells may be improved by generating first timing information and second timing information for at least one of the standard cells, based on different layout contexts, and storing the information in a library.

According to example embodiments, a method of designing a semiconductor device includes generating input data defining an integrated circuit; generating, based on the input data, layout data in which at least some selected standard cells among a plurality of standard cells stored in a library are disposed and connected; and analyzing timing of the integrated circuit using the layout data. The library stores physical information and timing information of each of the plurality of standard cells. For at least one standard cell among the plurality of standard cells, first timing information generated from a first layout context, and second timing information generated from a second layout context having an area of an interconnection pattern smaller than an area of an interconnection pattern of the first layout context, are stored in the library. In the analyzing the timing, the second timing information, different from the first timing information, is applied to at least one selected standard cell among the selected standard cells.

According to example embodiments, a method of designing a semiconductor device includes determining an arrangement of an active region and a gate structure of each of elements included in one standard cell providing a predetermined circuit; determining an arrangement of interconnection patterns connecting the elements and generating a first layout context and a second layout context with the interconnection patterns disposed differently in the first layout context and the second layout context; determining a design parameter including at least one of a process for each of the elements and an operating voltage input to the elements; simulating, based on the design parameter, an operation of the circuit implemented according to each of the first layout context and the second layout context; and generating, based on results of the simulation, first timing information of the predetermined circuit implemented according to the first layout context and second timing information of the predetermined circuit implemented according to the second layout context, based on results of the simulating.

According to example embodiments, a method of designing a semiconductor device includes generating, for each of a plurality of standard cells, physical information defining an arrangement of an active region, a gate structure, and interconnection patterns disposed along predetermined tracks, first timing information calculated based on a first layout context including a first quantity of the interconnection patterns, and second timing information calculated based on a second layout context including a second quantity of the interconnection patterns, the second quantity of the interconnection patterns being less than the first quantity of interconnection patterns; generating layout data by disposing and connecting at least some selected standard cells among the plurality of standard cells, based on input data defining an integrated circuit; and performing a timing analysis of the integrated circuit by applying the second timing information to some selected standard cells among the selected standard cells and applying the first timing information to remaining selected standard cells among the selected standard cells.

According to example embodiments, a semiconductor device includes a clock generator configured to output a clock signal; a plurality of unit circuits configured to operate in synchronization with the clock signal; and a clock tree including a plurality of clock repeaters connected between the clock generator and the plurality of unit circuits, and providing a transmission path of the clock signal input to each of the plurality of unit circuits. Standard cells providing the plurality of clock repeaters respectively include interconnection patterns extending in a first direction, an active region below the interconnection patterns, and a gate structure below the interconnection patterns and extending in a second direction, intersecting the first direction. In at least one standard cell among the standard cells, the interconnection patterns are disposed within boundaries of the at least one standard cell.

### BRIEF DESCRIPTION OF DRAWINGS

The above and other aspects, features, and advantages of the present inventive concept will be more clearly understood from the following detailed description, taken in conjunction with the accompanying drawings, in which:

FIG. 1 is a flowchart illustrating a method of manufacturing a semiconductor device according to an example embodiment;

FIG. 2 is a flowchart illustrating a method of designing a semiconductor device according to an example embodiment;

FIG. 3 is a diagram schematically illustrating a computer system capable of executing a method of designing a semiconductor device according to an example embodiment;

FIGS. 4 to 6 are graphs illustrating timing violations in an integrated circuit included in a semiconductor device according to an example embodiment;

FIGS. 7 to 9 are diagrams schematically illustrating layout data generated by a method of designing a semiconductor device according to an example embodiment;

FIG. 10 is a flowchart illustrating a method of designing a standard cell according to an example embodiment;

FIG. 11 is a diagram illustrating physical information of a standard cell stored in a library according to an example embodiment;

FIGS. 12 and 13 are diagrams illustrating timing information of standard cells stored in a library according to an example embodiment;

FIG. 14 is a diagram illustrating physical information of a standard cell stored in a library according to an example embodiment;

FIGS. 15 and 16 are diagrams illustrating timing information of standard cells stored in a library according to an example embodiment;

FIG. 17 is a diagram illustrating physical information of a standard cell stored in a library according to an example embodiment;

FIGS. 18 and 19 are diagrams illustrating timing information of standard cells stored in a library according to an example embodiment;

FIG. 20 is a diagram schematically illustrating a clock transmission circuit included in a semiconductor device according to an example embodiment;

FIGS. 21 and 22 are diagrams illustrating a setup time violation of an integrated circuit included in a semiconductor device according to an example embodiment;

FIGS. 23 and 24 are diagrams illustrating a hold time violation of an integrated circuit included in a semiconductor device according to an example embodiment; and

FIGS. 25 and 26 are drawings illustrating a method of designing a semiconductor device according to an example embodiment.

### DETAILED DESCRIPTION

Hereinafter, example embodiments will be described with reference to the accompanying drawings.

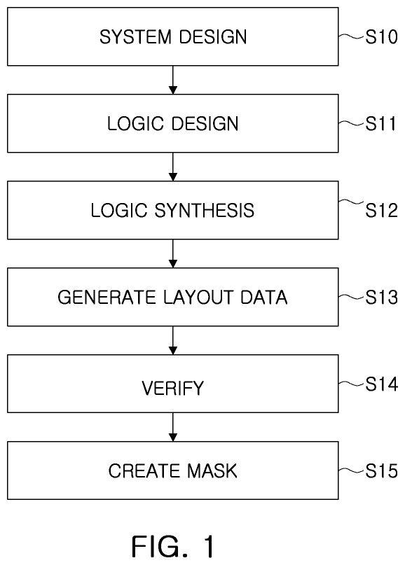

FIG. 1 is a flowchart illustrating a method of manufacturing a semiconductor device according to an example embodiment.

Referring to FIG. 1, the semiconductor device manufacturing method may begin with system design (S10). At the system design stage, the performance requirements and chip functions for the semiconductor device to be manufactured, for example, a semiconductor chip, may be determined according to the design specifications. For example, chip functions may be represented as functional modules or blocks, and various designs may be performed at this stage to obtain design specifications considering acceptable cost and power.

Once the system design is completed, the logic design may proceed (S11). At the logical design stage, functions such as blocks or modules corresponding to integrated circuits included in the semiconductor device at the system design stage may be defined at the register transfer level (RTL) based on a specific language. For example, RTL data is generated by languages such as VHSIC Hardware Description Language (VHDL), Verilog, etc. Additional verification tasks may be performed to determine whether the circuit design defined by RTL data complies with design specifications.

In the logic synthesis operation (S12), netlist data consisting of logic gates may be generated using RTL data. In an example embodiment, the circuit design in RTL data is expressed in a simple manner, such as connection information for each logic, and in the logic synthesis stage, a library in which standard cells are defined may be referenced to actually implement the same.

When netlist data is generated through logic synthesis, layout data may be generated using the netlist data as input data (S13). For example, layout data may be generated by determining at least some selected standard cells among standard cells stored in a library and arranging and connecting the selected standard cells. In the placement and connection task, a task of placing selected standard cells determined from among standard cells stored in the library on a two-dimensional plane and a routing task of connecting the arranged selected standard cells to each other may be performed.

For example, when layout data is created through a placement and connection operation, a verification operation may be executed (S14). Verification operations may verify whether an integrated circuit designed with layout data satisfies design specifications. For example, a timing analysis task may be performed. If it is determined that the layout data satisfies the design specifications in the verification task, the layout data may be output by the placement and connection task.

When layout data is output, a mask may be created based thereon (S15). Depending on the example embodiment, optical proximity correction work to reduce the difference between the mask generated based on the layout data and the layout data is performed first, and afterwards, a mask for performing a photolithography process, etc. may be created based on the layout data. Once the mask is created, the semiconductor process may proceed based thereon.

The physical information and timing information of each standard cell stored in the library may be used in various ways, such as in the logic synthesis operation (S12), the layout data generation operation (S13), and the verification operation (S14). For example, to generate layout data based on netlist data such as the type and number of gates required to implement an integrated circuit and the connection relationship between gates, physical information and timing information for each standard cell may be needed. Layout data should define the arrangement and connection relationships of standard cells to implement integrated circuits on an actual wafer. Therefore, the physical information defining the arrangement of the active region, gate structure, and interconnection pattern in each of the standard cells may also be generated based on timing information necessary for each standard cell to operate normally.

When designing each of the standard cells stored in the library, timing information may be generated by assuming a worst case, considering tolerances that may occur in the semiconductor process that actually implements the integrated circuit. For example, by assuming a case where additional interconnection patterns are arranged, in addition to the interconnection patterns required for the operation of an actual standard cell, timing information may be generated based on a worst case scenario in which the influence of parasitic capacitance or coupling components is increased.

In this manner, by generating timing information assuming the worst case and conducting timing analysis on the layout data based thereon, the risk of timing violation that may occur in the integrated circuit may be reduced. However, if the worst case is assumed in all areas of the integrated circuit, the difference between the layout data that serves as the basis for timing analysis and the actually implemented integrated circuit is bound to increase. Layout data including standard cells arranged and connected so that they may actually operate may be determined to be a timing violation in timing analysis. Therefore, the accuracy of the design work of the semiconductor device may decrease.

In an example embodiment, in addition to first timing information generated based on the first layout context of the worst case for at least one standard cell among standard cells stored in the library, second timing information generated based on a second layout context that is more similar to what is actually implemented on the wafer may be further generated. When designing layout data and executing tasks such as timing analysis thereof, the second timing information may be applied to standard cells such as clock repeaters and hold buffers that are sensitive to timing violations. Therefore, the accuracy of semiconductor device design work may be improved.

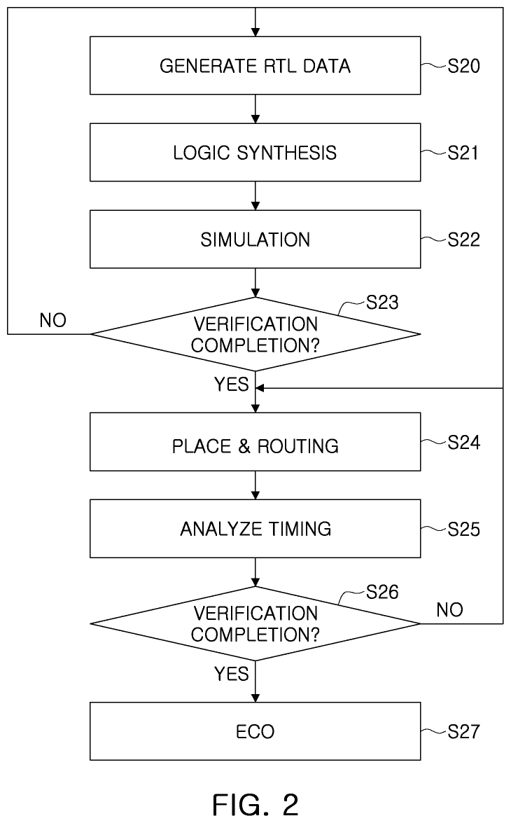

FIG. 2 is a flowchart illustrating a method of designing a semiconductor device according to an example embodiment.

The method of manufacturing a semiconductor device according to an example embodiment may begin with generating RTL data (S20). As described above, RTL data generated by RTL design may define the function of an integrated circuit included in a semiconductor device. When RTL data is generated, logic synthesis to generate netlist data from the RTL data using standard cells stored in the library may be performed (S21). Netlist data may include data defining standard cells and connection relationships between standard cells, and may be generated by a predetermined semiconductor design tool. Each of the standard cells may provide any one of a variety of circuits such as AND, OR, NOR, inverter, Or And Inverter (OAI), And Or Inverter (AOI), flip-flop, latch, etc.

Afterwards, a simulation task to verify the netlist data may be executed (S22). The simulation task in operation (S22) may be defined as a pre-layout simulation that is executed before generating layout data. Based on the results of completing the simulation work in operation (S22), it is determined whether verification of the netlist data has been completed (S23), and when some functions fail verification, the RTL data may be modified, or the system-level design may be modified by going back to the previous system design stage.

On the other hand, when verification of the netlist data is completed, a place & routing task that generates layout data with reference to the netlist data may be executed (S24). The Place & Routing work of operation S24 may be executed with reference to standard cells stored in the library. For example, the library may include physical information defining the layout of each standard cell, and timing information determined by the manufacturing process or operating voltage of the elements included in each standard cell. A semiconductor design tool that performs Place & Routing tasks may generate layout data including placement information of standard cells and routing information connecting the placed standard cells by referring to library and netlist data in which standard cells are stored.

Once the Place & Routing work is completed, timing analysis may be performed based on the layout data generated in operation S24 (S25). Timing analysis may verify whether timing violations occur in an integrated circuit. Based on the result of completing the timing analysis in operation (S25), it is determined whether the verification of the layout data has been completed (S26), and when the layout data does not pass verification, the Place & Routing tasks may be rerun or the RTL data may be modified. Or, depending on the example embodiment, the system design task, which is an RTL data transfer task, may be re-executed.

If it is determined that verification of the layout data has been completed in operation S26, optimization work may be performed (S27). The optimization task in operation S27 may be defined as Engineering Change Order (ECO). In optimization work, at least some of the standard cells may be replaced with other standard cells, or place and routing thereof may be changed.

As described above, in an example embodiment, for at least some of the standard cells stored in the library, first timing information based on the first layout context and second timing information based on the second layout context may be generated. The second layout context may include interconnection patterns arranged at a relatively low density, as compared to the first layout context.

In performing timing analysis based on layout data, in an example embodiment, timing analysis may be performed by applying second timing information instead of the first timing information to standard cells in some areas where timing violations are likely to occur, such as clock repeaters and hold buffers. Therefore, timing analysis may be performed using layout data with a structure more similar to an integrated circuit actually implemented on a wafer, etc. By improving the accuracy of timing analysis work, the efficiency of design work may be improved.

Additionally, in an example embodiment, the second timing information may be used in optimizing layout data. For example, after timing analysis of the layout data is completed, at least one layout among standard cells included in the layout data may be replaced from the first layout context to the second layout context. For example, among the standard cells included in the layout data, for a standard cell determined to contain unnecessary metal interconnection, by changing the layout to the second layout context, the power consumption and timing characteristics of the integrated circuit manufactured based on the layout data may be improved.

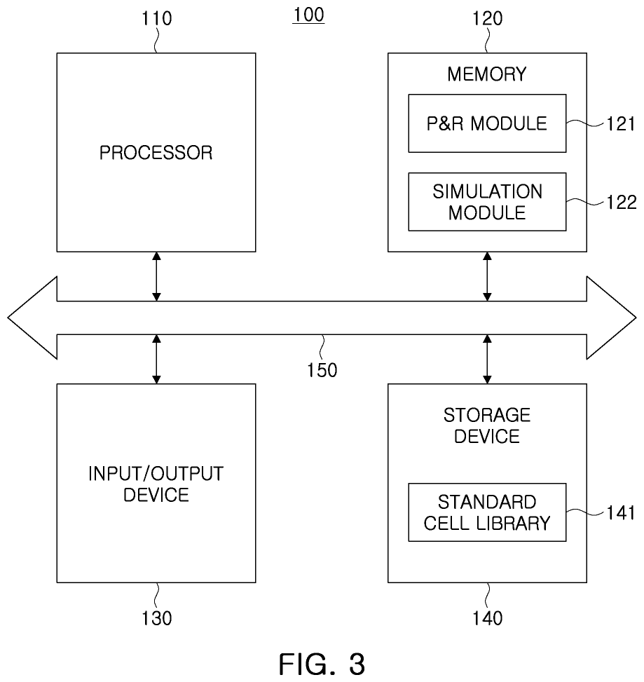

FIG. 3 is a diagram schematically illustrating a computer system capable of executing a method of designing a semiconductor device according to an example embodiment.

Referring to FIG. 3, a computer system 100 for designing an integrated circuit according to some embodiments may include a processor 110, a memory 120, an input/output device 130, a storage device 140, and a bus 150. The computer system 100 may be implemented as an integrated device, for example. The computer system 100 may be provided as a dedicated device for designing integrated circuits, for example. Computer system 100 may be, for example, a computer for executing various simulation tools or design tools.

The processor 110 may be configured to execute instructions that perform at least one of various operations for designing an integrated circuit. The processor 110 may include a core capable of executing arbitrary instructions, such as a microprocessor, an application processor (AP), a digital signal processor (DSP), or a graphics processing unit (GPU).

The processor 110 may communicate with the memory 120, the input/output device 130, and the storage device 140 through the bus 150. The processor 110 may design an integrated circuit by driving the Place & Routing (P&R) module 121 and the simulation module 122 loaded into the memory 120. Depending on the example embodiment, the module loaded into the memory 120 may further include a module for timing analysis in addition to the Place & Routing module 121 and the simulation module 122.

Each of the modules loaded into the memory 120 may be a program or software module including a plurality of instructions executed by the processor 110, and may be stored on a computer-readable storage medium. The Place & Routing module 121 and the simulation module 122 may be loaded from the storage device 140. The memory 120 may be volatile memories such as SRAM, DRAM, and the like, or non-volatile memories such as PRAM, MRAM ReRAM, and FRAM NOR flash memory.

The input/output device 130 is equipped with an input device such as a keyboard, mouse, touchpad, etc., and may receive input data defining an integrated circuit. Additionally, the input/output device 150 may be equipped with an output device such as a display, a speaker, etc. to display placement results, routing results, or timing analysis results.

The storage device 140 may store the Place & Routing module 121, the simulation module 122, etc., and various data required for integrated circuit design. For example, the storage device 140 may store a standard cell library in which standard cells are defined. The storage device 140 may include, for example, a memory card (MMC, eMMC, SD, MicroSD), solid state drive (SSD), hard disk drive (HDD), etc.

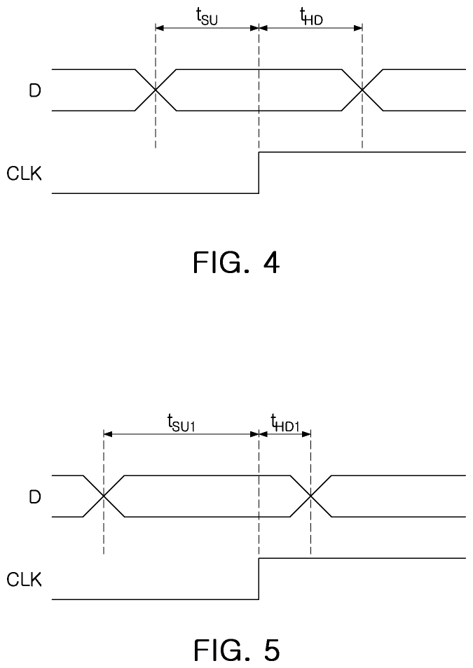

FIGS. 4 to 6 are graphs illustrating timing violations of an integrated circuit included in a semiconductor device according to an example embodiment.

As described above, the method of designing a semiconductor device according to an example embodiment includes generating netlist data by performing logic synthesis based on RTL data, and performing tasks such as creating layout data by placing and connecting standard cells stored in the library based on netlist data, etc. Additionally, a timing analysis task may be performed to verify timing violations for each of the netlist data and/or layout data. Hereinafter, with reference to FIGS. 4 to 6, examples of timing violations that may be detected in a timing analysis operation based on netlist data and/or layout data will be described.

Referring to FIGS. 4 to 6, the waveforms of the data input signal (D) and the clock signal CLK input to a scan flip-flop are illustrated, respectively. First, referring to FIG. 4, the setup time (t_{SU}) may mean the minimum time that the data input signal (D), which is an input signal, should maintain a constant value before the rising edge of the clock signal (CLK) arrives. In detail, the setup time (t_{SU}) may correspond to the minimum time required to determine whether the waveform of the data input signal (D) is a high logic value or a low logic value. On the other hand, the hold time (t_{HD}) may mean the minimum time that the data input signal (D) should maintain a constant value after the clock signal (CLK) is switched at the rising edge. In detail, the hold time (t_{HD}) may correspond to the minimum time for which the result determined from the rising edge of the clock signal (CLK) should be maintained.

Setup time (t_{SU}) and hold time (t_{HD}) are timing requirements for scan flip-flops, and such timing requirements may be one of the design rules for scan flip-flops. Setup time margin may refer to a time of the setup time or more, and hold time margin may refer to a time of the hold time or more. Setup time margin and hold time margin are also timing requirements of the scan flip-flop and may be one of the design rules for the scan flip-flop. In the method of designing a semiconductor device according to an example embodiment, timing analysis is performed using netlist data and/or layout data, and netlist data and/or layout data may be verified by comparing the setup time and hold time of the scan flip-flop detected as a result of timing analysis with the setup time and hold time defined in the design rule.

FIG. 5 is a graph to explain a hold time violation of a scan flip-flop according to an example embodiment. In the example illustrated in FIG. 5, as a result of timing analysis, the first setup time (t_{SU1}) is equal to or longer than the setup time (t_{SU}) illustrated in FIG. 4, and the first hold time (t_{HD1}) may be less than or equal to the hold time (t_{HD}) illustrated in FIG. 4. Therefore, since the data input signal (D) changes before the hold time (t_{HD}) (i.e., t_{HD1} is less than t_{HD}), which is the minimum time required after the rising edge of the clock signal CLK, it may be determined as a hold time violation.

FIG. 6 is a graph illustrating setup time violation of a scan flip-flop according to an example embodiment of the present disclosure. In an example embodiment illustrated in FIG. 6, the second setup time (t_{SU2}) may be less than or equal to the setup time (t_{SU}) illustrated in FIG. 4, and the second hold time (t_{HD2}) may be greater than or equal to the hold time (t_{HD}) illustrated in FIG. 4. Therefore, since the data input signal (D) is changed first before the setup time (t_{SU}) (i.e., t_{SU2} is less than t_{SU}), which is the minimum time required before the rising edge of the clock signal (CLK), it may be determined as a setup time violation.

As described with reference to FIGS. 4 to 6, the method of designing a semiconductor device according to an example embodiment may include a timing analysis task to detect timing violations in various components of an integrated circuit. However, the timing information of the standard cell provided by the library where the standard cell is stored may be generated from a layout context assuming a worst case where the influence of parasitic capacitance or coupling components is very large. Therefore, there may be differences from the layout of the integrated circuit actually implemented on a wafer. Accordingly, due to this difference, although operation without a timing violation is possible in an integrated circuit actually implemented on a wafer, a timing violation may be detected in a timing analysis operation performed using netlist data and/or layout data. In this case, unnecessary design modification work, etc. may be added, which may reduce the efficiency of the semiconductor device design work.

In an example embodiment, when performing timing analysis on an integrated circuit that includes components that may significantly affect timing violations, such as clock repeaters and hold buffers, separate timing information generated from a layout context similar to an integrated circuit implemented on an actual wafer may be used. Therefore, unnecessary design modification work may be omitted by increasing the accuracy of timing analysis work, and the efficiency of design work may be improved.

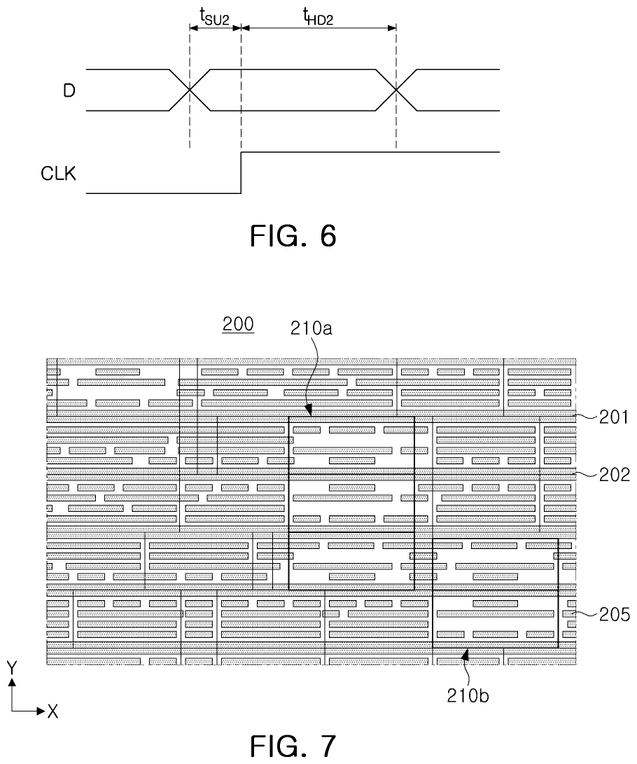

FIGS. 7 to 9 are diagrams schematically illustrating layout data generated by a method of designing a semiconductor device according to an example embodiment.

First, FIG. 7 may be a diagram simply illustrating a partial area of layout data 200 to be designed using a design method according to an example embodiment. As illustrated in FIG. 7, layout data 200 may include a plurality of standard cells (as shown in the example standard cell groupings 210a and 210b) arranged along a first direction (X-axis direction) and a second direction (Y-axis direction). A plurality of power interconnections 201 and 202 extending in the first direction along the boundary between the plurality of standard cells may be arranged in the second direction.

Referring to FIG. 7, the plurality of interconnection patterns 205 disposed on the same layer as the plurality of power interconnections 201 and 202 may also extend in the first direction. Each of the plurality of interconnection patterns 205 is connected to an active region, a gate structure, etc. located on a lower layer than the plurality of interconnection patterns 205 through a contact, or may be connected to an upper interconnection pattern disposed on a higher level than the plurality of interconnection patterns 205. In an example embodiment, the width of each of the plurality of interconnection patterns 205 may be smaller than the width of each of the plurality of power interconnections 201 and 202.

When layout data 200 is generated as in the example embodiment illustrated in FIG. 7, timing analysis may be performed based thereon. Timing violation cases, such as hold time violations and/or setup time violations, as described above with reference to FIGS. 4 to 6 may be detected through the timing analysis operation. Timing analysis uses timing information for each standard cell stored in the library. Timing information may vary depending on the manufacturing process, operating voltage, and density and arrangement of interconnection patterns connecting the elements, etc. of the elements included in the circuit defined by each standard cell.

In an example embodiment, first timing information and second timing information may be generated for at least one standard cell among standard cells and stored in a library. For example, the first timing information for one standard cell is generated based on a first layout context 220 as illustrated in FIG. 8, and the second timing information may be generated based on a second layout context 230 as illustrated in FIG. 9.

Referring to FIGS. 8 and 9, the gate structures GS may be arranged in the same location and in the same number in each of the first layout context 220 and the second layout context 230 for the standard cell. Additionally, the first power interconnection 201 and the second power interconnection 202 arranged along the border of the standard cell may also have the same shape.

However, as illustrated in FIGS. 8 and 9, the number of interconnection patterns 223 and 225 arranged by the first layout context 220 may be greater than the number of interconnection patterns 233 arranged by the second layout context 230. For example, the interconnection patterns 223 and 233 that are commonly present at the same location in each of the first layout context 220 and the second layout context 230 may be interconnection patterns that are connected to the elements of a standard cell and are actually formed on the wafer by the semiconductor process that manufactures integrated circuits.

On the other hand, unlike the second layout context 230, a dummy interconnection pattern 225 may exist in the first layout context 220. The dummy interconnection pattern 225 may be an interconnection pattern that is not formed on the wafer through a semiconductor process for manufacturing an integrated circuit. For example, the dummy interconnection pattern 225 may be an interconnection pattern that is arbitrarily added only to the layout data 200 to assume a worst case of a standard cell during a timing analysis task. Accordingly, the first timing information calculated in the first layout context 220 illustrated in FIG. 8 may be different from the second timing information calculated in the second layout context 230 illustrated in FIG. 9.

Because the dummy interconnection pattern 225 is not formed in an integrated circuit manufactured on a wafer etc. based on the layout data 200, the actual timing characteristics of the integrated circuit may be more similar to the timing analysis result using the second timing information generated based on the second layout context 230, as illustrated in FIG. 9. In an example embodiment, for one standard cell, first timing information and second timing information are generated based on different first and second layout contexts 220 and 230, respectively, and by performing timing analysis by selecting one of the first timing information and the second timing information, the accuracy of timing analysis may be improved.

For example, when timing analysis is performed using the first timing information even though a timing violation does not occur in an integrated circuit including interconnection patterns 233 such as the second layout context 230, due to the characteristics of the first layout context 220 including the dummy interconnection pattern 225, a timing violation may be detected. In an example embodiment, timing analysis is performed by applying second timing information instead of the first timing information to components where timing violations are likely to be detected, such as clock repeaters, hold buffers, etc., thereby increasing the accuracy of timing analysis and improving the efficiency of design work.

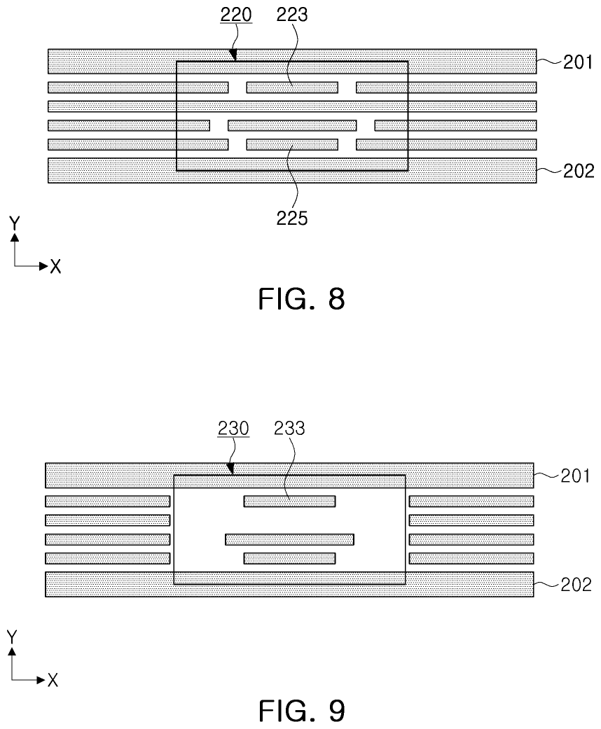

FIG. 10 is a flowchart illustrating the design method of a standard cell according to an example embodiment.

Referring to FIG. 10, the standard cell design method may begin with designing a circuit (S30). Depending on the type of circuit to be provided as a standard cell, the circuit design results at operation S30 may vary. For example, if a standard cell provides a NAND gate, two PMOS devices and two NMOS devices may be included in one standard cell.

Once the circuit design is completed, the components that should be included in the standard cell may be placed and routing work to connect the components to each other may be performed (S31). The components may be devices such as transistors, and in the routing task, the arrangement of interconnection patterns connecting the elements to each other may be determined.

For example, despite containing the same components according to the standard cell, routing may be different. For example, a standard cell providing a NAND gate and a standard cell providing a NOR gate each include two PMOS devices and two NMOS devices, but place and/or routing thereof may be different. When place and routing components, the design rules of the standard cell, such as the pitch between gate structures and the width and height of the standard cell, may be considered.

Once the Place & Routing of components is completed, a first layout context and a second layout context may be created for one standard cell. As previously described with reference to FIGS. 8 and 9, the first layout context may have a higher density of interconnection patterns than the second layout context, and for example, a dummy interconnection pattern that is not included in the second layout context may be included in the first layout context.

Alternatively, unlike the first layout context in which all tracks on which interconnection patterns may be placed are filled with interconnection patterns, in the second layout context, at least one of the tracks may be designated as a block area in which interconnection patterns are not actually placed. The block area may be designated only as a partial area of at least one of the tracks, or, depending on the example embodiment, at least one entire track may be designated as a block area. Accordingly, the number of interconnection patterns arranged according to the first layout context may be greater than the number of interconnection patterns arranged according to the second layout context. Additionally, the area of the interconnection patterns arranged according to the first layout context may be larger than the area of the interconnection patterns arranged according to the second layout context.

Afterwards, simulation for the standard cell may be run (S33). In the simulation, it is verified whether the standard cell operates like the circuit designed in operation S30, and timing information may be generated (S34). For example, simulation may use design parameters including the process of forming each element included in a standard cell and the operating voltage input to the elements. For example, even in the case of a standard cell providing the same circuit, timing information according to simulation results may be generated differently depending on the process of determining the scale of each element, the size of the operating voltage input to each element, etc.

On the other hand, even when simulation is performed using the same design parameters, since the parasitic capacitance, coupling component, etc. generated by the interconnection patterns defined by the first layout context are different from the parasitic capacitance, coupling component, etc. generated by the interconnection patterns defined by the second layout context, the first timing information generated from the first layout context may be different from the second timing information generated from the second layout context. In an example embodiment, both first timing information and second timing information for one standard cell may be stored in the library.

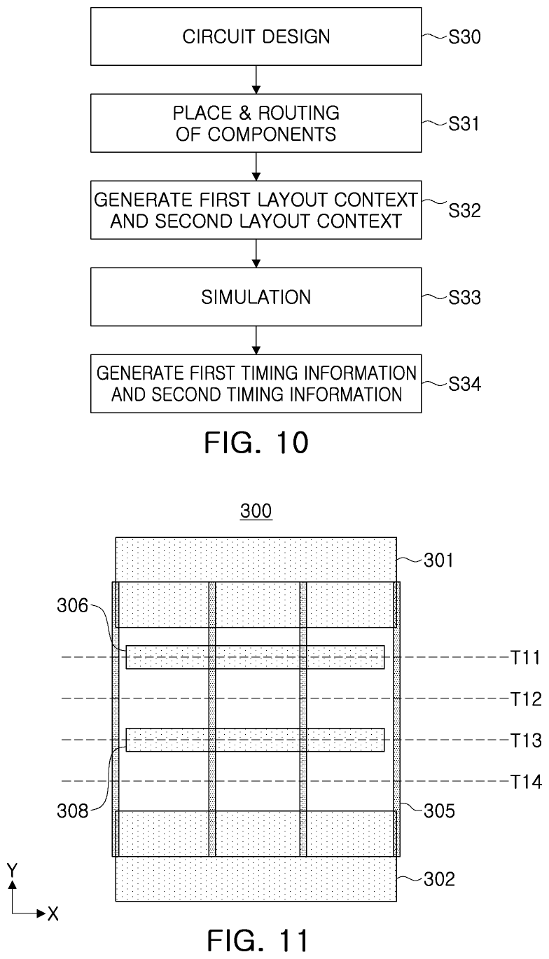

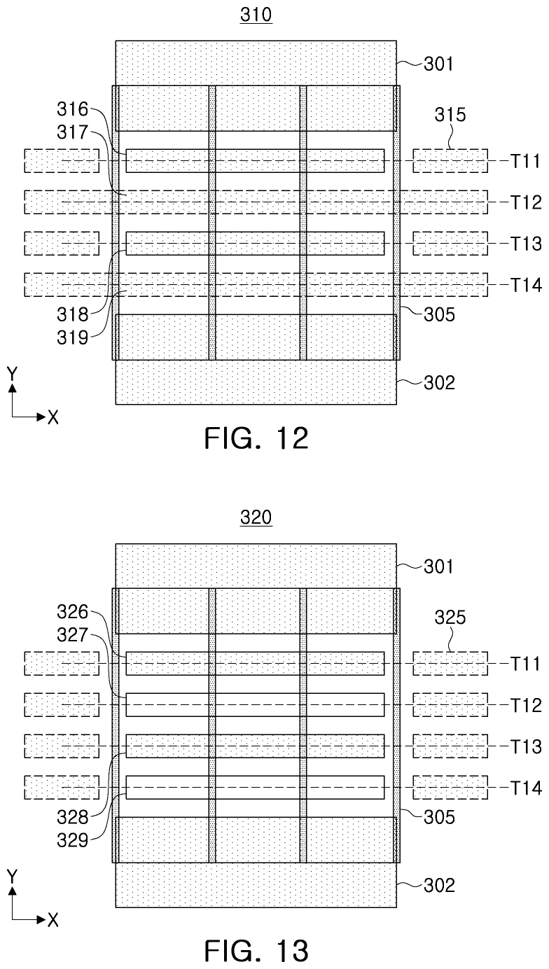

FIG. 11 is a diagram illustrating physical information of a standard cell stored in a library according to an example embodiment. FIGS. 12 and 13 are diagrams illustrating timing information of standard cells stored in a library according to an example embodiment.

First, referring to FIG. 11, physical information of a standard cell may be generated based on the actual layout 300 of the standard cell. The layout 300 of the standard cell may include the location and shape of each of the plurality of interconnections 301, 302, 306, and 308 and the location of the gate structure 305. Although not illustrated in FIG. 11, the layout 300 may also include the shape and size of the active region that provides devices such as transistors together with the gate structure 305, and the shape and location of contacts connecting the gate structure 305 and the active region with the interconnections 301, 302, 306, and 308.

A plurality of interconnections 301, 302, 306, and 308 may extend in the first direction (X-axis direction) and may include power interconnections 301 and 302 that transmit power voltages, and interconnection patterns 306 and 308. In an example, the power interconnections 301 and 302 are arranged along the boundary of the standard cell and extend in a first direction, and the interconnection patterns 306 and 308 may extend in the first direction along predetermined tracks T11-T14. In the standard cell according to the example embodiment illustrated in FIG. 11, the first interconnection pattern 306 is disposed at a position corresponding to the first track T11, and the second interconnection pattern 308 may be disposed at a position corresponding to the third track T13. On the other hand, interconnection patterns may not be disposed at positions corresponding to the second track T12 and the fourth track T14.

However, timing information of standard cells stored in the library may not be generated from the actual layout 300 as illustrated in FIG. 11. To generate timing information of a standard cell, a layout context different from the actual layout 300 as illustrated in FIG. 11 may be separately defined, and timing information may be generated based thereon. This may be to ensure sufficient margin within the integrated circuit in consideration of delays and errors that may occur during the signal transmission process.

In the layout context defined to generate timing information, a greater number and higher density of interconnection patterns may be arranged compared to the actual layout 300. For example, referring to FIG. 12, the first layout context 310 defined to generate first timing information may include interconnection patterns 315 to 319. The first to fourth interconnection patterns 316-319 are arranged along predefined tracks T11-T14, and therefore, unlike the actual layout 300, in the first layout context 310, interconnection patterns 316-319 may be arranged in all tracks T11-T14.

In addition, in the actual layout 300, the second interconnection pattern 317 and the fourth interconnection pattern 319 are additionally disposed on the empty second track T12 and fourth track T14, and may extend across the boundary of the standard cell along the first direction to the outside of the standard cell. On the other hand, the first interconnection pattern 316 and the third interconnection pattern 318 corresponding to the interconnection patterns 306 and 308 of the actual layout are placed only inside the boundary of the standard cell, but fifth interconnection patterns 315 may be additionally disposed beyond the boundaries of the standard cells in each of the first track T11 and the third track T13.

By configuring the first layout context 310 in this manner, the parasitic capacitance and coupling components generated in the interconnection patterns 315-319 may be set to be larger than the actual layout 300. By generating first timing information based on a first layout context 310 with worse conditions than the actual layout 300 and analyzing the timing of an integrated circuit including a standard cell based thereon, integrated circuits with sufficient margin that timing violations do not occur may be designed.

However, when analyzing the timing of an integrated circuit by applying timing information generated based on the first layout context 310 with a high interconnection pattern density for all standard cells included in the integrated circuit, according to the actual layout 300, although normal operation is possible without a timing violation, there is a possibility that the analysis result may be incorrectly derived as a timing violation occurs. In this case, the efficiency of design work may be reduced because work such as modifying at least some of the components of the actual layout 300 or modifying RTL data should be performed again.

In an example embodiment, the efficiency of design work may be increased by generating a plurality of timing information based on different layout contexts for one standard cell and using the same for timing analysis. For example, for one standard cell, second timing information based on the second layout context 320, which is different from the first layout context 310 as illustrated in FIG. 12, may be additionally generated. Both first timing information and second timing information for a standard cell may be stored in the library.

As illustrated in FIG. 13, interconnection patterns having a relatively small area compared to the first layout context 310 may be arranged in the second layout context 320. Referring to FIG. 13, in the second layout context 320, similar to the actual layout 300, in the area within the standard cell, the interconnection patterns 326 and 328 may be disposed only at positions corresponding to the first track T11 and the third track T13. Positions corresponding to the second track T12 and the fourth track T14 may be set as block areas 327 and 329 where interconnection patterns cannot be placed.

Therefore, except for the fifth interconnection pattern 325 disposed at a position corresponding to the first track T11 and the third track T13 outside the boundary of the standard cell, in the second layout context 320, the interconnection patterns 326 and 328 for connecting the active region of the standard cell and the gate structure 305 may be arranged within the boundary of the standard cell similar to the actual layout 300. In addition, the fifth interconnection pattern 325 disposed outside the boundary of the standard cell is not directly connected to the interconnection patterns 326 and 328 disposed within the boundary of the standard cell, and may not extend to the area within the boundary of the standard cell due to the block areas 327 and 329.

When analyzing the timing of an integrated circuit, second timing information generated based on the second layout context 320 similar to the actual layout 300 may be applied to at least one of the standard cells. For example, for a standard cell that provides a clock repeater placed in the transmission path of a clock signal and/or a hold buffer included in an integrated circuit to minimize hold time violations, etc., when analyzing the timing of an integrated circuit, the second timing information calculated from the second layout context 320 may be applied. Therefore, the operation timing of the integrated circuit may be analyzed under conditions more similar to the actual layout 300, and by increasing the accuracy of analysis results, the efficiency of design work for integrated circuits may be improved.

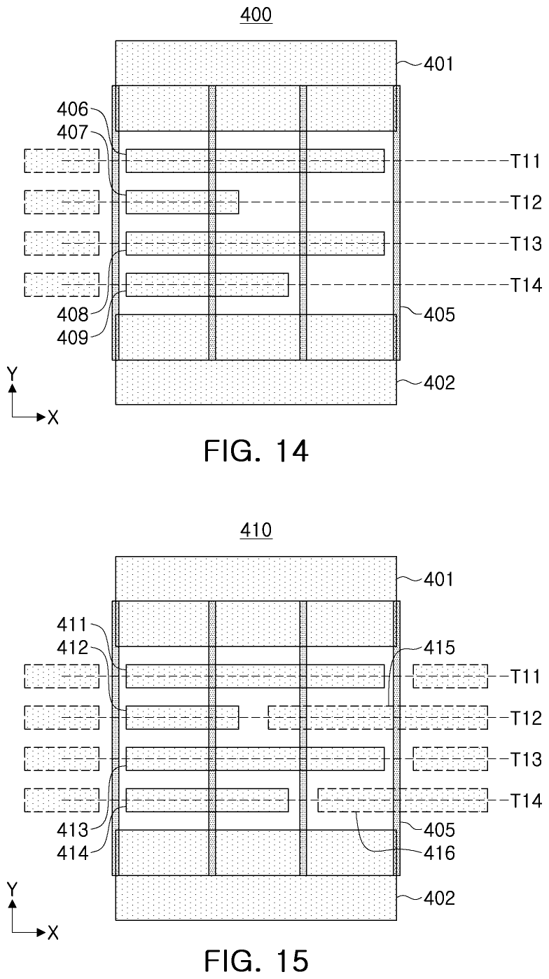

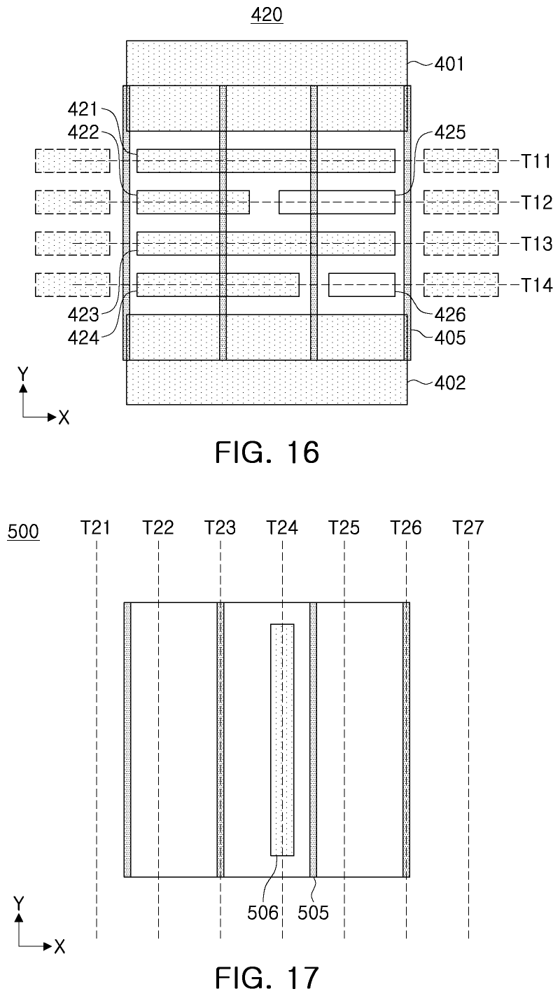

FIG. 14 is a diagram illustrating physical information of a standard cell stored in a library according to an example embodiment. FIGS. 15 and 16 are diagrams illustrating timing information of standard cells stored in a library according to an example embodiment.

Referring to FIG. 14, by the layout 400 of a standard cell, the positions and shapes of each of the plurality of interconnections 401, 402, 406, 407, 408, and 409, the position of the gate structure 405, and the size and shape of the active region formed on the substrate may be defined. Physical information of a standard cell may be generated based on the layout 400. A plurality of interconnections 401, 402, and 406-409 may include power interconnections 401 and 402 extending in the first direction (X-axis direction) and arranged along the boundary of the standard cell, and interconnection patterns 406-409 arranged along predetermined tracks T11-T14. According to the layout 400 of a standard cell according to an example embodiment illustrated in FIG. 14, interconnection patterns 406-409 may be arranged in all tracks T11 to T14.

The timing information of the standard cell may be generated based on the first layout context 410 illustrated in FIG. 15 and the second layout context 420 illustrated in FIG. 16, that are different from the actual layout 400 as illustrated in FIG. 14. In the library, first timing information generated from the first layout context 410 and second timing information generated from the second layout context 420 may be stored along with the physical information of the standard cell.

Referring to FIGS. 15 and 16, the interconnection patterns 411-416 defined by the first layout context 410 may be arranged at a relatively high density compared to the interconnection patterns 421-424 defined by the second layout context 420. For example, block areas 425 and 426 in which interconnection patterns cannot be placed are defined in the second layout context 420, and interconnection patterns 421-424 within a standard cell may be arranged in the same form as the actual layout 400. Therefore, the second timing information generated from the second layout context 420 may more accurately reflect the characteristics of the integrated circuit manufactured based on the actual layout 400, compared to the first timing information generated from the first layout context 410.

In an example embodiment, first timing information and second timing information are generated based on different layout contexts 410 and 420 for one standard cell, and by selectively using this for timing analysis, the efficiency of design work may be increased. For example, when analyzing the timing of an integrated circuit, second timing information generated based on a second layout context 420 similar to the actual layout 400 may be used for at least one of the standard cells. For example, for standard cells that provide clock repeaters and/or hold buffers, the second timing information may be used when analyzing the timing of an integrated circuit. Therefore, the operation timing of the integrated circuit may be analyzed under conditions more similar to the actual layout 400, and by increasing the accuracy of analysis results, the efficiency of design work for integrated circuits may be improved.

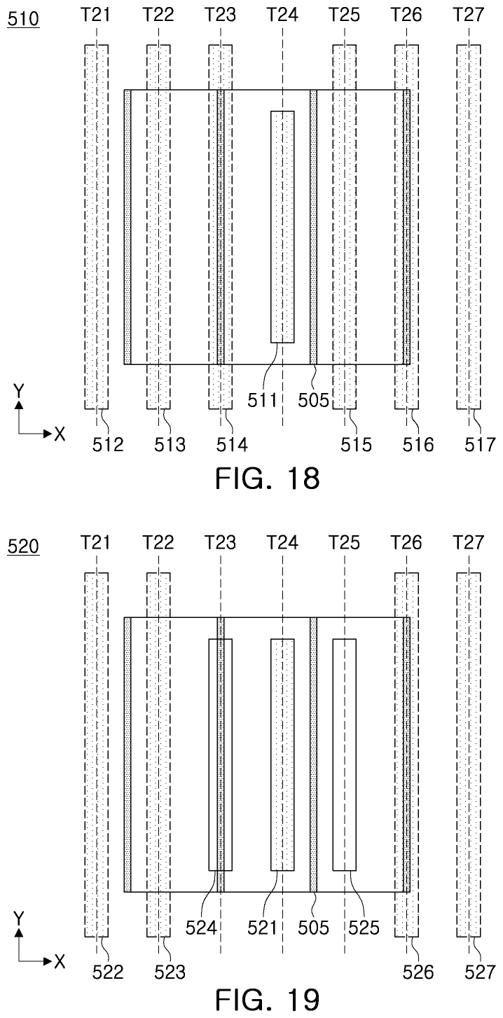

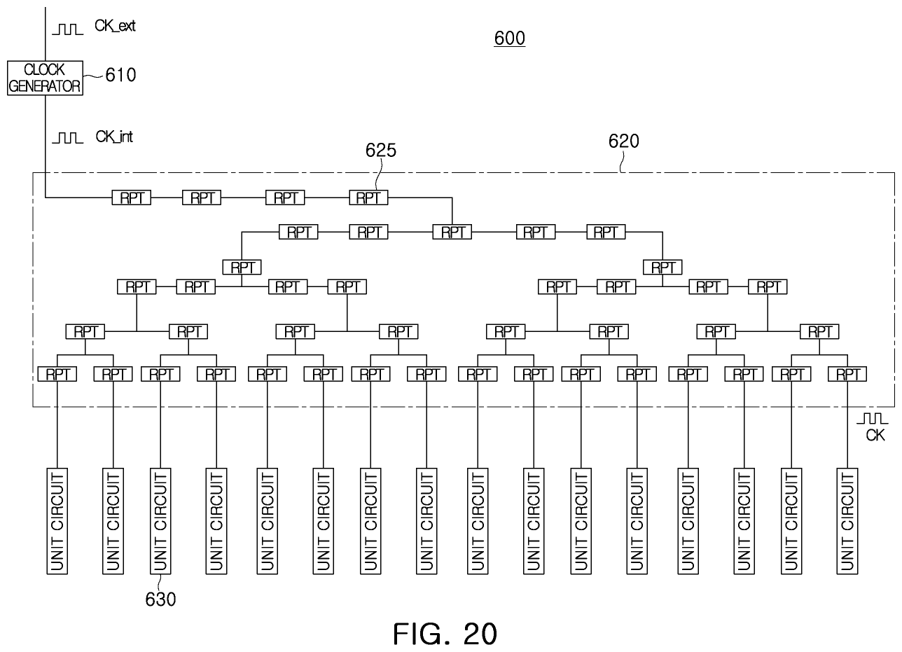

FIG. 17 is a diagram illustrating physical information of a standard cell stored in a library according to an example embodiment. FIGS. 18 and 19 are diagrams illustrating timing information of standard cells stored in a library according to an example embodiment.

Referring to FIG. 17, by the layout 500 of a standard cell, the location of the gate structure 505, the size and shape of the active region formed on the substrate, and the location and shape of the interconnection 506 may be defined. Physical information of a standard cell may be generated based on the layout 500. In an example embodiment illustrated in FIG. 17, the interconnection 506 may extend along the same second direction (Y-axis direction) as the gate structure 505, and for example, the interconnection 506 may be placed on a higher layer than the interconnections previously described with reference to FIGS. 11 to 16.

Similar to what was previously described, the interconnection 506 may be placed in at least one of the predetermined tracks T21-T27. According to the layout 500 of a standard cell according to an example embodiment illustrated in FIG. 17, the interconnection pattern 506 may be disposed only on the fourth track T24.

On the other hand, the timing information of the standard cell may be generated based on the first layout context 510 and the second layout context 520 that are different from the actual layout 500 as illustrated in FIG. 17. The library includes physical information of standard cells representing the actual layout 500, and first timing information generated from the first layout context 510 and second timing information generated from the second layout context 520 may be stored.

Referring to FIG. 18, interconnection patterns 511 to 517 defined in the first layout context 510 may be defined in all tracks T21 to T27, unlike the actual layout 500. Like the actual layout 500 in which interconnection pattern 506 is disposed on the fourth track T24, the interconnection pattern 511 may be disposed on the fourth track T24. However, interconnection patterns 512-517 may be additionally disposed on the remaining tracks T21-T23 and T25-T27. Accordingly, timing information may be calculated under conditions where parasitic capacitance and coupling components due to the interconnection patterns 511-517 are increased.

On the other hand, referring to FIG. 19, the interconnection patterns 521-523, 526, and 527 defined by the second layout context 520 may be arranged at a relatively low density. For example, in the second layout context 520, block areas 524 and 525 in which interconnection patterns cannot be placed may be defined in some tracks T23 and T25. Accordingly, the second layout context 520 may be relatively more similar to the actual layout 500 than the first layout context 510, and the second timing information generated from the second layout context 520 may more accurately reflect the characteristics of the integrated circuit manufactured based on the actual layout 400 than the first timing information.

In an example embodiment, first timing information and second timing information are generated for one standard cell based on the first layout context 510 and the second layout context 520, and by selectively using this for timing analysis, the efficiency of design work may be increased. For example, when applying the first timing information to the task of analyzing the timing of layout data for manufacturing an integrated circuit, in reality, a timing violation may be detected even though the layout data is designed to enable normal operation. In this case, the layout data or RTL data before logic synthesis should be modified, and the efficiency of the design work is inevitably reduced.

In an example embodiment, for a standard cell that provides a clock repeater and/or a hold buffer, etc., which have a significant impact on timing violations, the timing of the integrated circuit may be analyzed by applying the second timing information generated based on the second layout context 520 having the block areas 524 and 525. Therefore, the operation timing of the integrated circuit may be analyzed under conditions more similar to the actual layout 500, and by increasing the accuracy of analysis results, the efficiency of design work for integrated circuits may be improved.

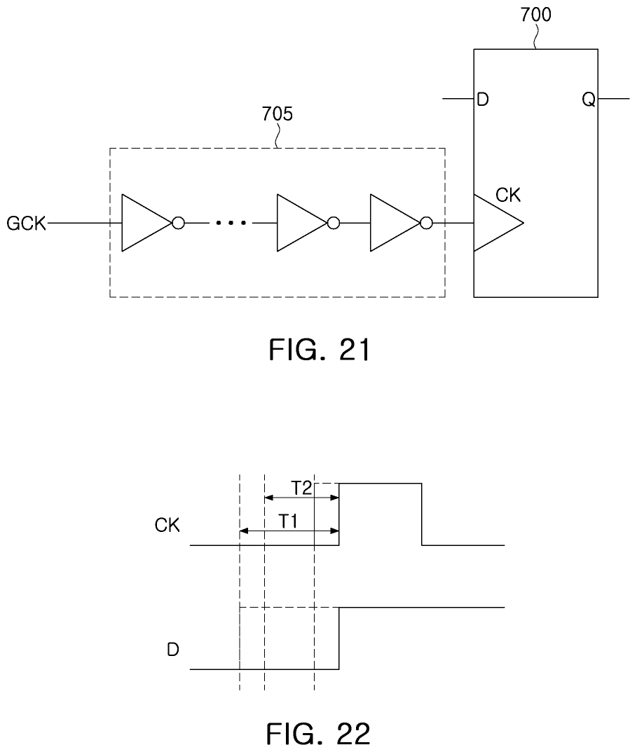

FIG. 20 is a diagram schematically illustrating a clock transmission circuit included in a semiconductor device according to an example embodiment.

Referring to FIG. 20, the semiconductor device 600 may include a clock generator 610 that generates an internal clock (CK_int) using an external clock (CK_ext), a clock tree 620 that delivers the internal clock (CK_int) to a plurality of unit circuits 630, etc. The clock tree 620 may include a plurality of clock repeaters (RPT, 625), and for example, each of the plurality of clock repeaters 625 may include at least one buffer. The unit circuits 630 may be circuits that operate in synchronization with the operation clock CK output by the clock tree 620.

In an example embodiment illustrated in FIG. 20, clock repeaters 625 included in the clock tree 620 may be connected to each other according to an H-tree structure. All transmission paths connecting the clock generator 610 and the unit circuits 630 may have the same delay time. Accordingly, the operation clocks CK input to the unit circuits 630 may have substantially the same phase.

Layout data for manufacturing a semiconductor device 600 such as the example embodiment illustrated in FIG. 20 may be generated, and timing analysis tasks may be executed based on layout data. Layout data may be created by placing and connecting multiple standard cells. Some of the standard cells may provide clock repeaters 625 included in the clock tree 620.

For example, in timing analysis based on layout data, to prevent timing violations from occurring in each of the unit circuits 630 of the semiconductor device 600 actually manufactured through a semiconductor process, timing information generated by a layout context in which interconnection patterns are arranged at a higher density than the actual layout of each standard cell providing the clock tree 620 may be used. By this method, while layout data may be generated under safe conditions in which timing violations do not occur, despite the structure in which timing violations do not occur in the semiconductor device 600 actually manufactured through a semiconductor process, it may be incorrectly analyzed that a timing violation will occur, which may require additional work such as modifying layout data.

In accordance with aspects of the present inventive concept, for a standard cell that provides circuitry that may affect timing violations, such as a clock repeater 625, timing analysis may be performed by applying timing information generated based on a layout context similar to the actual layout. In the case of a layout context similar to the actual layout, block areas may be defined in the remaining tracks excluding the interconnection patterns required to connect elements in the actual layout. Therefore, the accuracy of timing analysis may be improved and design work efficiency may be increased by omitting unnecessary additional work.

In this manner, when timing analysis is performed using a layout context in which block areas are defined in the remaining tracks excluding the interconnection patterns defined in the layout of the standard cell to connect devices, a block area may also be defined in standard cells included in layout data for creating a mask. Accordingly, each of the standard cells providing the clock repeaters 625 included in the clock tree 620 may include a track on which no interconnection patterns are arranged.

In an example, each of the standard cells providing clock repeaters 625 includes an active region, gate structure, and interconnection patterns, and some or all of the interconnection patterns may be placed on the M1 layer, which is the lowest layer closest to the active region. The interconnection patterns disposed on the M1 layer may extend in one direction as previously described with reference to FIGS. 11 to 16.

In the task of analyzing the timing of layout data for manufacturing the semiconductor device 600, timing information for each of the standard cells providing clock repeaters 625 may be created from a layout context that specifies a block area so that additional interconnection patterns cannot be placed in tracks and areas other than the actual interconnection patterns defined in the layout of each standard cell. To increase the accuracy of timing analysis, the same block area as the layout context may be assigned to each of the standard cells that provide clock repeaters 625 in the layout data.

Therefore, as previously described with reference to FIGS. 11 to 16, the interconnection patterns disposed on the M1 layer in each of the standard cells providing the clock repeaters 625 may be disposed within the boundary of each standard cell and may not extend beyond the boundary to other adjacent standard cells. Additionally, interconnection patterns disposed on the M1 layer in other adjacent standard cells may also be separated from the boundaries of the standard cells providing the clock repeaters 625 and may not extend beyond the boundaries of the standard cells.

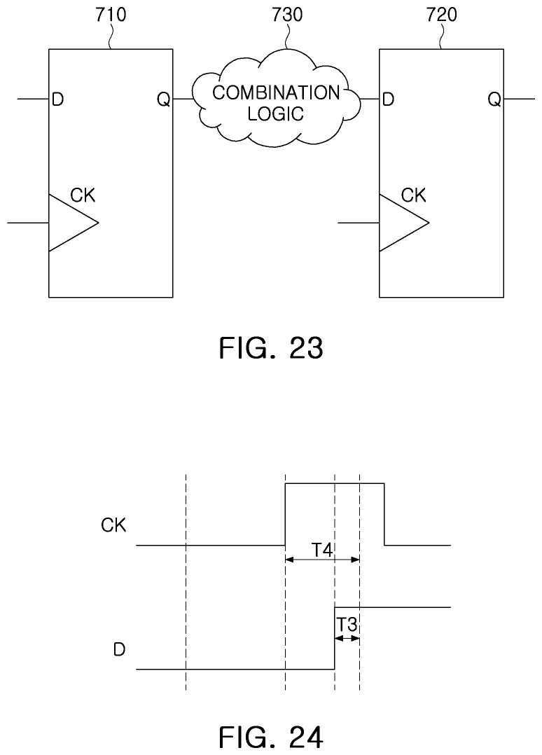

FIGS. 21 and 22 are diagrams illustrating a setup time violation of an integrated circuit included in a semiconductor device according to an example embodiment.

First, referring to FIG. 21, a data input signal (D) and a clock signal (CK) may be input to the flip-flop 700. The clock signal (CK) may be a signal input to the flip-flop 700 after the global clock signal GCK passes through the clock cell 705.

As described above, the setup time may be the minimum time that the data input signal (D) should maintain a constant value before the rising edge of the clock signal (CK) arrives. In an example embodiment illustrated in FIGS. 21 and 22, the setup margin time to which a margin is added to prevent setup time violation may be the first time (T1). If the first time (T1) is longer than the second time (T2), which is the setup time of the flip-flop 700, setup time violation may be effectively prevented.

In the layout data, the flip-flop 700 and clock cell 705 may be implemented by placing and connecting a plurality of standard cells. Before forming a mask using layout data and implementing a process using the mask to implement the flip-flop 700 and clock cell 705 on the wafer, timing analysis work that verifies whether a timing violation occurs using layout data may be preceded.

Timing analysis may be performed using timing information stored in a library for each of a plurality of standard cells providing the flip-flop 700 and the clock cell 705. Timing information for each standard cell varies depending on various parameters such as operating voltage and sizes of elements implemented in the standard cell, and therefore, multiple pieces of timing information for one standard cell may be generated and stored in the library.

For example, timing information for a standard cell may be calculated from a layout context in which additional interconnection patterns are arranged, in addition to the interconnection patterns required to implement a single circuit by connecting elements included in the standard cell. This may be to ensure a safe design that does not cause timing violations by intentionally increasing the influence of parasitic capacitance or coupling components. In the above example, one circuit may be a gate level circuit, for example, a NAND gate, an inverter, a NOR gate, etc. In this manner, timing analysis is performed using the timing information calculated from the layout context in which additional interconnection patterns are placed, and the layout data is modified by referring to the results. The flip-flop 700 and clock cell 705 may be designed with sufficient margin to prevent setup time violations.

However, when using the layout context as described above, unnecessary margin may be added, which may reduce the performance of the integrated circuit or increase power consumption. In addition, even though the layout data is designed to be actually operable, a timing violation may be detected in a timing analysis based on a layout context in which additional interconnection patterns are arranged. In this case, unnecessary layout data modification work is performed, which may also reduce the efficiency of design work.

In an example embodiment, for one standard cell, a first layout context and a second layout context in which interconnection patterns are arranged differently are defined, and based thereon, first timing information and second timing information may be generated. For example, compared to the first layout context, the number of interconnection patterns added to the actual layout of the standard cell may be smaller in the second layout context. For example, an area in which additional interconnection patterns are arranged in the first layout context may be defined as a block area in the second layout context. Therefore, when timing analysis is performed using the second timing information generated based on the second layout context of the standard cell, more accurate analysis results may be obtained.

In this manner, the second timing information generated based on the second layout context may be applied to standard cells that provide the clock cell 705. By applying the second timing information to the standard cells providing clock cell 705, a circuit that may have a relatively greater impact on timing violations, and the accuracy of timing analysis may be improved and unnecessary modification of layout data may be minimized.

In an example embodiment, once the timing analysis is completed, the block area defined in the second layout context may be actually applied to the standard cell providing the clock cell 705. Accordingly, in the layout data used for mask manufacturing, each of the standard cells providing a transmission path for the clock signal (CK) may commonly include a block area in which interconnection patterns cannot be placed. For example, the block area may be defined in the M1 layer, which is the layer where the interconnection patterns closest to the active region and gate structure in each standard cell are placed.

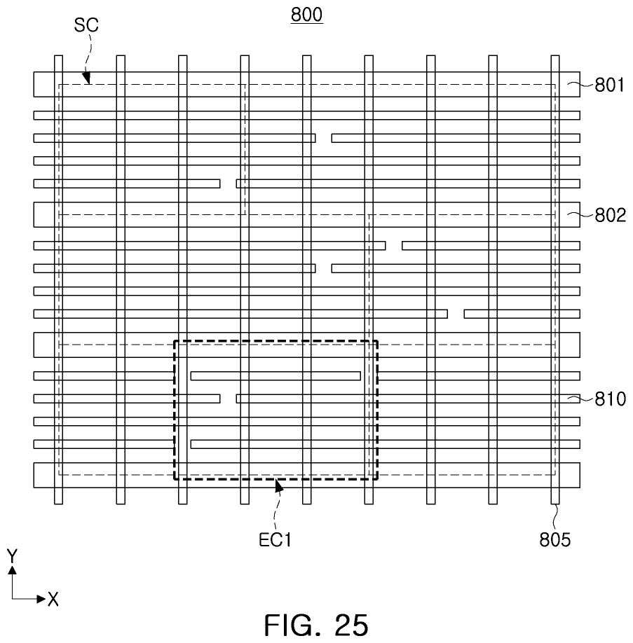

FIGS. 23 and 24 are diagrams illustrating a hold time violation of an integrated circuit included in a semiconductor device according to an example embodiment.

First, referring to FIG. 23, the first flip-flop 710 and the second flip-flop 720 may be connected to each other by combination logic 730. The combination logic 730 may be a circuit that transfers the data output signal (Q) of the first flip-flop 710 to the data input signal (D) of the second flip-flop 720. In an example embodiment, the combinational logic 730 includes a hold buffer, and a hold time violation in the second flip-flop 720 may be prevented by the delay time provided by the combinational logic 730.

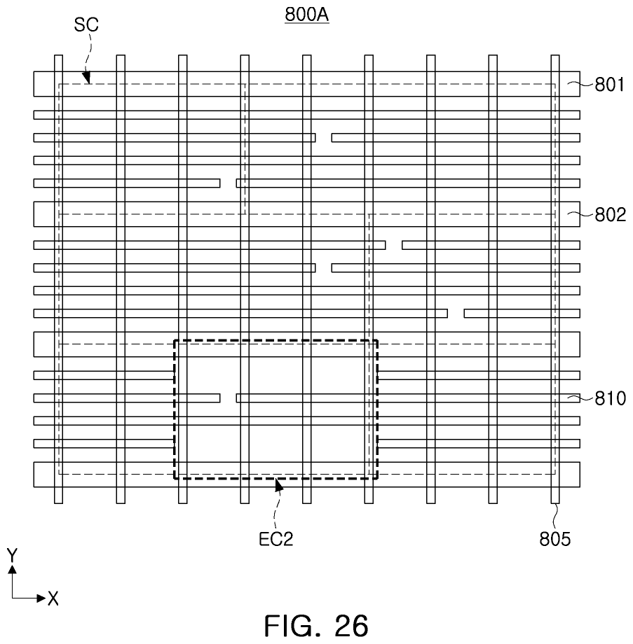

As described above, the hold time may be the minimum time that the data input signal (D) should maintain a constant value after the rising edge of the clock signal (CK). Referring to FIG. 25, the setup margin time to which a margin is added to prevent a hold time violation may be the fourth time (T4). In an example embodiment illustrated in FIG. 25, a hold time violation occurs because the data input signal (D) changes before the fourth time T4 elapses. The hold time violation may be resolved by providing a delay time of the third time (T3) or longer in the combination logic 730.

In the layout data, flip-flops 710 and 720 and combination logic 730 may be implemented by placing and connecting a plurality of standard cells. Before forming a mask using layout data and implementing a process using the mask to implement the flip-flops 710 and 720 and combination logic 730 on the wafer, timing analysis work that verifies whether a timing violation occurs using layout data may be preceded.

As previously described with reference to FIGS. 22 and 23, timing information previously generated for each standard cell and stored in a library may be used for timing analysis. In an example embodiment, first timing information and second timing information calculated from different layout contexts for at least some of the standard cells, for example, standard cells providing combination logic 730, may be stored in a library. The first timing information is calculated from the first layout context in which relatively many interconnection patterns are arranged, and the second timing information may be calculated from a second layout context in which relatively few interconnection patterns are arranged. Accordingly, the interconnection patterns defined by the second layout context may be more similar to the interconnection patterns included in the actual layout of the corresponding standard cell.

When the first timing information is used in timing analysis, the worst case may be considered, so a margin sufficient to more reliably prevent hold time violations may be secured. However, in reality, a hold time violation may be detected even for layout data that may be operated without a hold time violation, and unnecessary modification work may be added to the layout data. In an example embodiment, timing analysis is performed by applying the second timing information to the combination logic 730, so that unnecessary modification of the layout data may be omitted, and the efficiency of design work may be improved.

As described above, a block area in which interconnection patterns are not arranged may be defined in the second layout context. For standard cells using second timing information in timing analysis, the block area defined in the second layout context may also be applied to layout data. In this manner, the block area defined in the second layout context is applied to the standard cells included in the layout data, and additional delays that may occur in signals transmitted through the standard cell may be minimized and power consumption reduced.

FIGS. 25 and 26 are drawings illustrating a method of designing a semiconductor device according to an example embodiment.

FIG. 25 may be a diagram schematically illustrating a portion of layout data 800 generated by a method of designing a semiconductor device according to an example embodiment. FIG. 25 may be a diagram illustrating interconnections 801, 802, and 810 arranged in the M1 layer closest to the gate structure 805 and the active region among the interconnection patterns included in the layout data 800.

Referring to FIG. 25, the layout data 800 includes a plurality of standard cells SC arranged along a first direction (X-axis direction) and a second direction (Y-axis direction), and gate structures 805 may be arranged along a first direction and extend in a second direction. On the other hand, the plurality of interconnections 801, 802, and 810 may extend in the first direction and be arranged along the second direction. A plurality of interconnections 801, 802 and 810 may include power interconnections 801 and 802 that transmit power voltage and extend along the boundaries of standard cells (SC), and interconnection patterns 810 disposed between adjacent power interconnections 801 and 802 in the second direction.

When layout data 800 is generated and timing analysis is completed based on timing information generated for each standard cell (SC) included in the layout data 800 and stored in the library, ECO work may be carried out. The ECO operation may be an optimization operation that modifies at least part of the layout data 800.

In an example embodiment, the target cell (EC1) to be modified in the ECO task is selected, and the arrangement of the interconnection patterns 810 in the target cell (EC1) may be modified. For example, as illustrated in FIG. 26, other standard cells SC are maintained as is, and the arrangement of the interconnection patterns 810 in the target cell (EC1) is changed and replaced with a modified cell (EC2), thereby creating new layout data 800A.

Compared to the target cell (EC1), fewer interconnection patterns 810 may be disposed in the modified cell (EC2). This may be the result of setting the area in which the interconnection patterns 810, rather than the interconnection patterns 810 required for connecting devices included in the target cell (EC1), to be a block area. In the operation of modifying the arrangement of the interconnection patterns 810 of the target cell (EC1), as in the example embodiment described with reference to FIGS. 25 and 26, the first layout context and the second layout context that are predefined and stored in the library may be used as described above.

For example, the interconnection patterns 810 of the target cell (EC1) included in the layout data 800 illustrated in FIG. 25 may be the result of being arranged according to the first layout context. In this case, if it is determined that there is an unnecessary interconnection pattern among the interconnection patterns 810 passing through the target cell (EC1), in the ECO operation, the arrangement of the interconnection patterns 810 of the target cell (EC1) may be changed to the second layout context rather than the first layout context. Therefore, the target cell (EC1) may be replaced with a modified cell (EC2), and the delay and power consumption of the signal transmission path including the cell may be improved.

As set forth above, according to an example embodiment, first timing information and second timing information may be generated based on different layout contexts for at least one of the standard cells and may be stored in a library. In a simulation work of an integrated circuit designed with standard cells, the second timing information generated based on a layout context with a low density of interconnection patterns may be used for standard cells providing clock repeaters, hold buffers, and the like. Therefore, simulation work may be performed with layout data having a physical structure more similar to the integrated circuit actually manufactured by the process, and the efficiency of semiconductor device design work may be improved by increasing the accuracy of simulation work.

While example embodiments have been illustrated and described above, it will be apparent to those skilled in the art that modifications and variations could be made without departing from the scope of the present inventive concept as defined by the appended claims.

What is claimed is:

1. A method of designing a semiconductor device, comprising:
generating input data defining an integrated circuit;
generating, based on the input data, layout data in which at least some selected standard cells among a plurality of standard cells stored in a library are disposed and connected; and
analyzing timing of the integrated circuit using the layout data,
wherein the library stores
physical information and timing information of each of the plurality of standard cells, and
for at least one standard cell among the plurality of standard cells, first timing information generated from a first layout context, and second timing information generated from a second layout context having an area of an interconnection pattern smaller than an area of an interconnection pattern of the first layout context, the second timing information being different from the first timing information, and
wherein, in the analyzing the timing, the second timing information is applied to at least one selected standard cell among the selected standard cells.

2. The method of claim 1, wherein the physical information includes positions and shapes of an active region, a gate structure, and an interconnection pattern included in each of the plurality of standard cells.

3. The method of claim 1, wherein the at least one standard cell is included in a clock repeater disposed in a transmission path of a clock signal.

4. The method of claim 1, wherein the at least one standard cell is included in a hold buffer.

5. The method of claim 1, wherein the generating the input data includes,
generating register transfer level (RTL) data defining the integrated circuit; and
generating the input data implementing the integrated circuit with the selected standard cells, based on the RTL data.

6. The method of claim 5, further comprising:
executing a simulation verifying the input data.

7. The method of claim 6, wherein in the executing the simulation, the input data is verified using the second timing information for the at least one standard cell among the selected standard cells.

8. The method of claim 1, wherein, when analyzing timing of the integrated circuit using of the layout data is completed, at least one target cell is selected among the selected standard cells, and interconnection patterns included in the target cell are changed to interconnection patterns defined by the second layout context.

9. The method of claim 1, wherein in the at least one standard cell, a plurality of tracks corresponding to placeable positions of the interconnection patterns are defined, and
at least one of interconnection patterns defined by the first layout context is disposed in each of the plurality of tracks.

10. The method of claim 9, wherein a block area without the interconnection patterns is defined by the second layout context in at least one of the plurality of tracks.

11. A method of designing a semiconductor device, comprising:
determining an arrangement of an active region and a gate structure of each element included in one standard cell providing a predetermined circuit;
determining an arrangement of interconnection patterns connecting the elements and generating a first layout context and a second layout context with the interconnection patterns disposed differently in the first layout context and the second layout context;
determining a design parameter including at least one of a process for each of the elements and an operating voltage input to the elements;
executing, based on the design parameter, a simulation for an operation of the predetermined circuit implemented according to each of the first layout context and the second layout context; and
generating, based on results of the simulation, first timing information of the predetermined circuit implemented according to the first layout context and second timing information of the predetermined circuit implemented according to the second layout context, based on results of the simulation.

12. The method of claim 11, wherein the number of interconnection patterns defined by the first layout context is greater than the number of interconnection patterns defined by the second layout context.

13. The method of claim 11, wherein an area of interconnection patterns defined by the first layout context is larger than an area of interconnection patterns defined by the second layout context.

14. The method of claim 11, wherein in the standard cell, a plurality of tracks are defined corresponding to positions where the interconnection patterns may be placed, and
at least one interconnection pattern defined by the first layout context is disposed in each of the plurality of tracks.

15. The method of claim 14, wherein a block area in which the interconnection patterns are not disposed is defined in at least one of the plurality of tracks, by the second layout context.

16. The method of claim 15, wherein at least one of the plurality of tracks is defined as the block area by the second layout context.

17. A method of designing a semiconductor device, comprising:
generating, for each of a plurality of standard cells, physical information defining an arrangement of an active region, a gate structure, and interconnection patterns disposed along predetermined tracks, first timing information calculated based on a first layout context including a first quantity of the interconnection patterns, and second timing information calculated based on a second layout context including a second quantity of the interconnection patterns, the second quantity of the interconnection patterns being less than the first quantity of interconnection patterns;
generating layout data by disposing and connecting at least some selected standard cells among the plurality of standard cells, based on input data defining an integrated circuit; and
performing a timing analysis of the integrated circuit by applying the second timing information to some selected standard cells among the selected standard cells and applying the first timing information to remaining selected standard cells among the selected standard cells.

18. The method of claim 17, further comprising:
selecting at least one target cell among the selected standard cells and modifying the interconnection patterns disposed in the target cell with reference to the second layout context, when the timing analysis of the integrated circuit is completed.

19. The method of claim 17, wherein the some selected standard cells are included in at least one of a clock repeater disposed in a transmission path of a clock signal, and a hold buffer.

20. The method of claim 17, wherein a block area in which the interconnection patterns are not placed is defined in the second layout context.
